(19) United States
(12) Patent Application Publication
(10) Pub. No.: US 2009/0119189 A1
(43) Pub. Date: May 7, 2009

(54) INFORMATION DISSEMINATION SYSTEM AND METHOD

(76) Inventors: Brian R. McLane, New York, NY (US); Henry Chan, New York, NY (US); Tak Sing Chu, Brooklyn, NY (US); Steve Kamerman, Holland, MI (US)

Correspondence Address: HOLLAND & KNIGHT LLP, 10 ST. JAMES AVENUE, 11th Floor, BOSTON, MA, 02116-3889, US

(21) Appl. No.: 12/113,094

(22) Filed: Apr. 30, 2008

Related U.S. Application Data
(60) Provisional application No. 60/914,880, filed on Apr. 30, 2007.
(60) Provisional application No. 60/953,558, filed on Aug. 2, 2007.

(51) Int. Cl. G06Q 30/00; G06Q 50/00

(52) U.S. Cl. 705/27; 705/26

(57) ABSTRACT

A method and computer program product for allowing one or more clients to define a real estate listing for each of a plurality of available properties, thus defining a plurality of available real estate listings. Each of the plurality of available real estate listings includes one or more data items. A user is allowed to define one or more real estate preferences. At least one compatible real estate listing is identified for the user based upon the one or more real estate preferences. The at least one compatible real estate listing is chosen from the plurality of available real estate listings. Review is effectuated, on a handheld electronic device of the user, of at least a portion of the one or more data items of the at least one compatible real estate listing.

### RELATED APPLICATIONS

This disclosure claims the benefit of U.S. Provisional Patent Application No. 60/914,880, which is entitled REAL ESTATE JUKEBOX and was filed on 30 Apr. 2007.

### TECHNICAL FIELD

This disclosure relates to information dissemination systems and, more particularly, to real estate information dissemination systems.

### BACKGROUND

The Internet has clearly revolutionized the manner in which people handle everyday tasks. For example, people may shop online (which used to require going to a store), perform research online (which used to require going to a library), and book travel online (which used to require calling a travel agent/airline). Additionally, people may visit one or more of the commercial real estate websites and research properties that are available online. However, the “online” experience is short-lived when researching available real estate, as the user must then print out various webpages for the properties that they are interested in and travel to those properties to perform any meaningful research. Further, while the use of the Wireless Application Protocol (WAP) and mobile browsers (executed on handheld devices) have allowed for wireless access to various e-commerce websites, the use of such technology in the real estate market lags far behind.

### SUMMARY OF THE DISCLOSURE

In a first implementation, an information dissemination method includes allowing one or more clients to define a real estate listing for each of a plurality of available properties, thus defining a plurality of available real estate listings. Each of the plurality of available real estate listings includes one or more data items. A user is allowed to define one or more real estate preferences. At least one compatible real estate listing is identified for the user based upon the one or more real estate preferences. The at least one compatible real estate listing is chosen from the plurality of available real estate listings. Review is effectuated, on a handheld electronic device of the user, of at least a portion of the one or more data items of the at least one compatible real estate listing.

One or more of the following features may be included. The client may be registered. Registering the client may include one or more of: defining a client legal name; defining a client username and/or password; defining a client email address; defining a client title; defining a client gender; defining a client company name; and defining client contact information. The client may be a real estate broker.

Defining a real estate listing may include defining a listing plan for the real estate listing. The one or more data items may include one or more of: a textual description of an available property, a map locating the available property, a still image of the available property, and a video clip of the available property.

The textual description of the available property may include one or more of: an available property type, an available property city, an available property state, an available property price, an available property number of bedrooms, an available property number of bathrooms, an available property title, and an available property style descriptor. The one or more real estate preferences may include one or more of: a preferred property type, a preferred city, a preferred state, and a preferred price range.

The user may be registered, Registering the user may include one or more of: defining a user name; defining a user password; defining a user email address, and defining a unique identifier for the handheld electronic device of the user.

Defining a unique identifier for the handheld electronic device of the user may include one or more of: defining a cellular telephone number for the handheld electronic device of the user; and defining an email address for the handheld electronic device of the user.

Effectuating review may include: delivering a data link to the handheld electronic device of the user via a messaging protocol, wherein the link effectuates review, on the handheld electronic device of the user, of the at least a portion of the one or more data items of the at least one compatible real estate listing. The messaging protocol may include one or more of: a Short Message Service (SMS) protocol; and a Multimedia Messaging Service (MMS) protocol. The data link may be processable via a Wireless Application Protocol (WAP).

An administrator may be allowed to review/approve the one or more data items.

In another implementation, a computer program product resides on a computer readable medium having a plurality of instructions stored on it. When executed by a processor, the instructions cause the processor to perform operations including allowing one or more clients to define a real estate listing for each of a plurality of available properties, thus defining a plurality of available real estate listings. Each of the plurality of available real estate listings includes one or more data items. A user is allowed to define one or more real estate preferences. At least one compatible real estate listing is identified for the user based upon the one or more real estate preferences. The at least one compatible real estate listing is chosen from the plurality of available real estate listings. Review is effectuated, on a handheld electronic device of the user, of at least a portion of the one or more data items of the at least one compatible real estate listing.

One or more of the following features may be included. The client may be registered. Registering the client may include one or more of: defining a client legal name; defining a client username and/or password; defining a client email address; defining a client title; defining a client gender; defining a client company name; and defining client contact information. The client may be a real estate broker.

Defining a real estate listing may include defining a listing plan for the real estate listing. The one or more data items may include one or more of: a textual description of an available property, a map locating the available property, a still image of the available property, and a video clip of the available property.

The textual description of the available property may include one or more of: an available property type, an available property city, an available property state, an available property price, an available property number of bedrooms, an available property number of bathrooms, an available property title, and an available property style descriptor. The one or more real estate preferences may include one or more of: a preferred property type, a preferred city, a preferred state, and a preferred price range.

The user may be registered, Registering the user may include one or more of: defining a user name; defining a user password; defining a user email address, and defining a unique identifier for the handheld electronic device of the user.

Defining a unique identifier for the handheld electronic device of the user may include one or more of: defining a cellular telephone number for the handheld electronic device of the user; and defining an email address for the handheld electronic device of the user.

Effectuating review may include: delivering a data link to the handheld electronic device of the user via a messaging protocol, wherein the link effectuates review, on the handheld electronic device of the user, of the at least a portion of the one or more data items of the at least one compatible real estate listing. The messaging protocol may include one or more of: a Short Message Service (SMS) protocol; and a Multimedia Messaging Service (MMS) protocol. The data link may be processable via a Wireless Application Protocol (WAP).

An administrator may be allowed to review/approve the one or more data items.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an information dissemination process coupled to a distributed computing network;

FIG. 2 is a flowchart of a process executed by the information dissemination process of FIG. 1;

FIG. 3 is a screen rendered by the information dissemination process of FIG. 1;

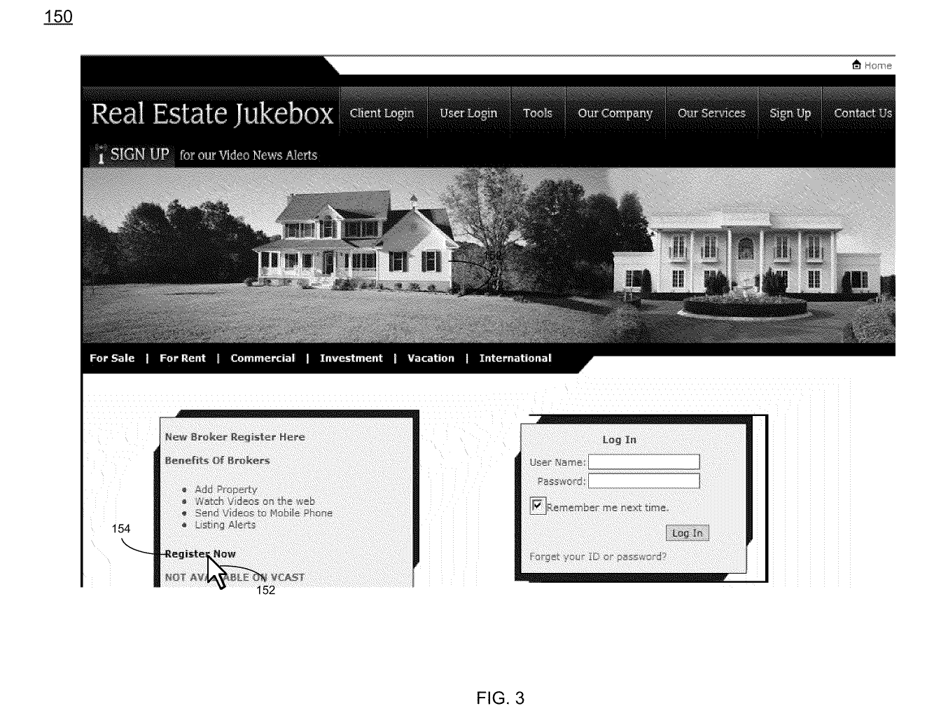

FIG. 4 is a screen rendered by the information dissemination process of FIG. 1;

FIG. 5 is a screen rendered by the information dissemination process of FIG. 1;

FIG. 6 is a screen rendered by the information dissemination process of FIG. 1;

FIG. 7 is a screen rendered by the information dissemination process of FIG. 1;

FIG. 8 is a screen rendered by the information dissemination process of FIG. 1;

FIG. 9 is a screen rendered by the information dissemination process of FIG. 1;

FIG. 10 is a screen rendered by the information dissemination process of FIG. 1;

FIG. 11 is a screen rendered by the information dissemination process of FIG. 1;

FIG. 12 is a screen rendered by the information dissemination process of FIG. 1;

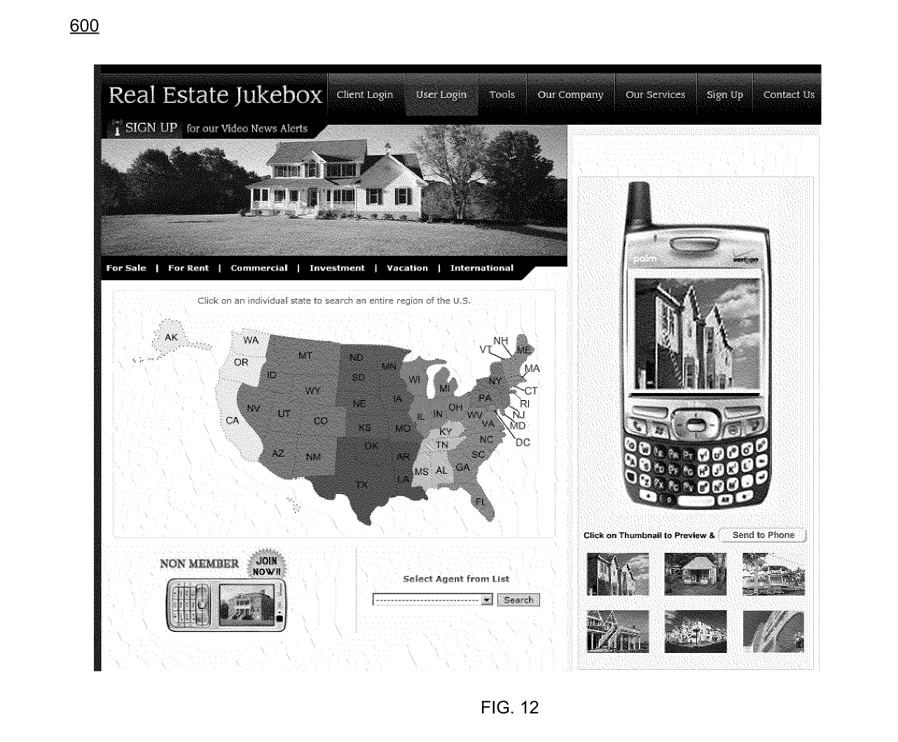

FIG. 13 is a screen rendered by the information dissemination process of FIG. 1;

FIG. 14 is a screen rendered by the information dissemination process of FIG. 1;

FIG. 15 is a screen rendered by the information dissemination process of FIG. 1; and

FIG. 16 is a screen rendered by the information dissemination process of FIG. 1.

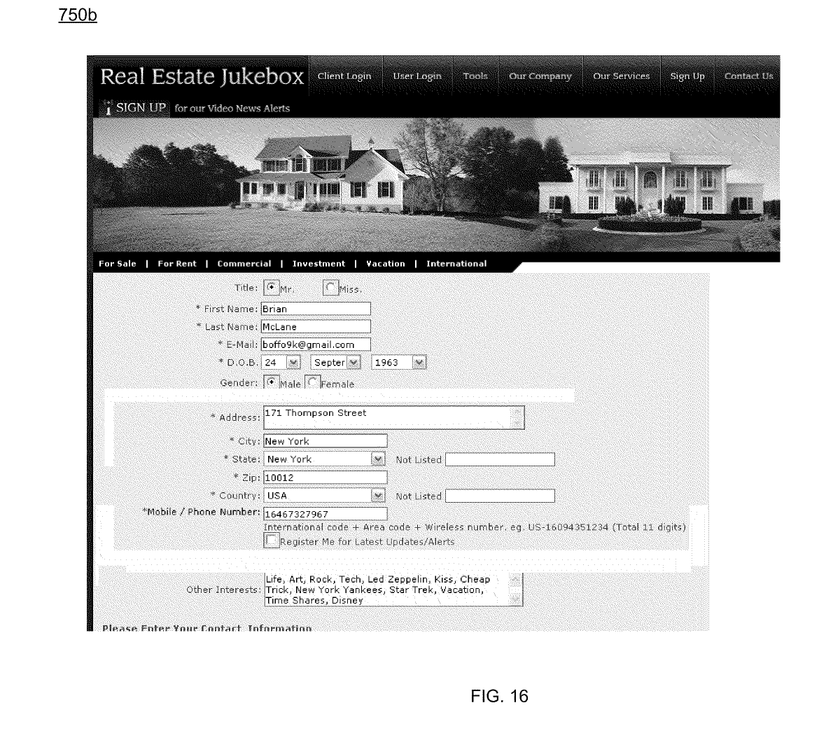

Like reference symbols in the various drawings indicate like elements.

### DETAILED DESCRIPTION OF THE DISCLOSURE

### System Overview

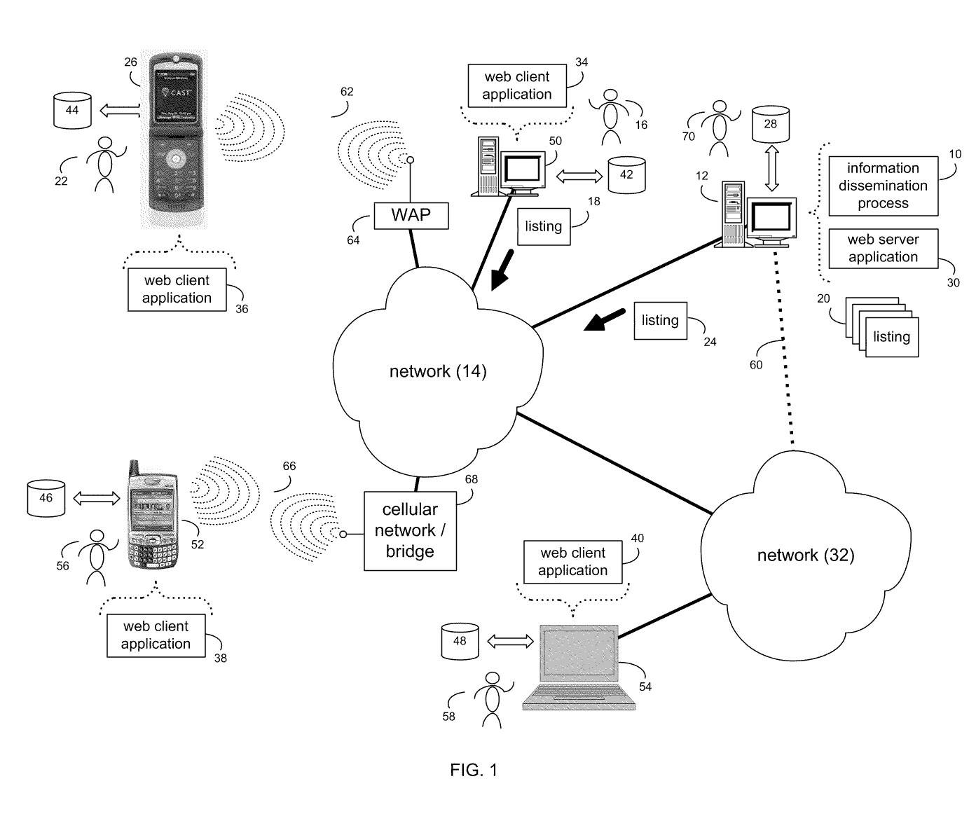

Referring to FIG. 1, there is shown information dissemination process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, information dissemination process 10 may allow one or more clients (e.g., client 16) to define a real estate listing (e.g., listing 18) for each of a plurality of available properties, thus defining a plurality of available real estate listings (e.g., plurality of listings 20). Each of plurality of available real estate listings 20 may include one or more data items. A user (e.g., user 22) may be allowed to define one or more real estate preferences and at least one compatible real estate listing (e.g., compatible listing 24) may be identified for the user based upon those real estate preferences. The compatible real estate listing(s) may be chosen from plurality of available real estate listings 20. Review of at least a portion of the data items of the compatible real estate listing(s) may be effectuated on a handheld electronic device (e.g., cellular telephone 26) of user 22,

The instruction sets and subroutines of information dissemination process 10, which may be stored on storage device 28 coupled to server computer 12, may be executed by one or more processors (not shown) and one or more memory architectures (not shown) incorporated into server computer 12. Storage device 28 may include but is not limited to: a hard disk drive; a tape drive; an optical drive; a RAID array; a random access memory (RAM); and a read-only memory (ROM).

Server computer 12 may execute web server application 30, examples of which may include but are not limited to: Microsoft IIS™, Novell Webserver™, or Apache Webserver™, that allows for e.g., HTTP (i.e., HyperText Transfer Protocol) access to server computer 12 via network 14. The instruction sets and subroutines of web server application 30, which may be stored on storage device 28 coupled to server computer 12, may be executed by one or more processors (not shown) and one or more memory architectures (not shown) incorporated into server computer 12.

Network 14 may be connected to one or more secondary networks (e.g., network 32), examples of which may include but are not limited to: a local area network; a wide area network; or an intranet, for example. Information dissemination process 10 may be a stand alone application that interfaces with web server application 30 or an applet/application that is executed within web server application 30.

The instruction sets and subroutines of web client applications 34, 36, 38, 40 which may be stored on storage devices 42, 44, 46, 48 (respectively) coupled to client electronic devices 50, 26, 52, 54 (respectively), may be executed by one or more processors (not shown) and one or more memory architectures (not shown) incorporated into client electronic devices 50, 26, 52, 54 (respectively). Storage devices 42, 44, 46, 48 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of web client applications 34, 36, 38, 40 may include Microsoft Internet Explorer™, Apple Safari™, Mozilla FireFox™, or a mobile browser application (e.g., Android™, Blackberry Browser™, Blazer™, Internet Explorer Mobile™, Motomagx™, and Opera Mobile™).

Examples of client electronic devices 50, 26, 52, 54 may include, but are not limited to, personal computer 50, cellular telephone 26, personal digital assistant 52, notebook computer 54, a laptop computer (not shown), and a dedicated network device (not shown), for example. Using web client applications 34, 36, 38, 40, client 16 and users 22, 56, 58 may allow access to one or more applications resident on and served by e.g., server computer 12 and/or web server application 30 (including but not limited to information dissemination process 30).

Client 16 and users 22, 56, 58 may access web server application 30 directly through the device on which the web client application (e.g., web client applications 34, 36, 38, 40) is executed, namely client electronic devices 50, 26, 52, 54, for example. Client 16 and users 22, 56, 58 may access web server application 30 directly through network 14 or through secondary network 32. Further, server computer 12 (i.e., the computer that executes web server application 30) may be connected to network 14 through secondary network 32, as illustrated with link line 60 (shown in phantom).

The various client electronic devices may be directly or indirectly coupled to network 14 (or network 32). For example, personal computer 50 is shown directly coupled to network 14 via a hardwired network connection. Further, notebook computer 54 is shown directly coupled to network 32 via a hardwired network connection. Cellular telephone 26 is shown wirelessly coupled to network 14 via wireless communication channel 62 established between cellular telephone 26 and wireless access point (i.e., WAP) 64, which is shown directly coupled to network 14. WAP 64 may be, for example, an IEEE 802.11a, 802.11b, 802.11g, Wi-Fi, and/or Bluetooth device that is capable of establishing wireless communication channel 62 between cellular telephone 26 and WAP 64. Personal digital assistant 52 is shown wirelessly coupled to network 14 via wireless communication channel 66 established between personal digital assistant 52 and cellular network/bridge 68, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 50, 26, 52, 54 may each execute an operating system, examples of which may include but are not limited to Microsoft Windows™, Microsoft Windows CE™, Redhat Linux™, or a custom operating system.

### System Operation:

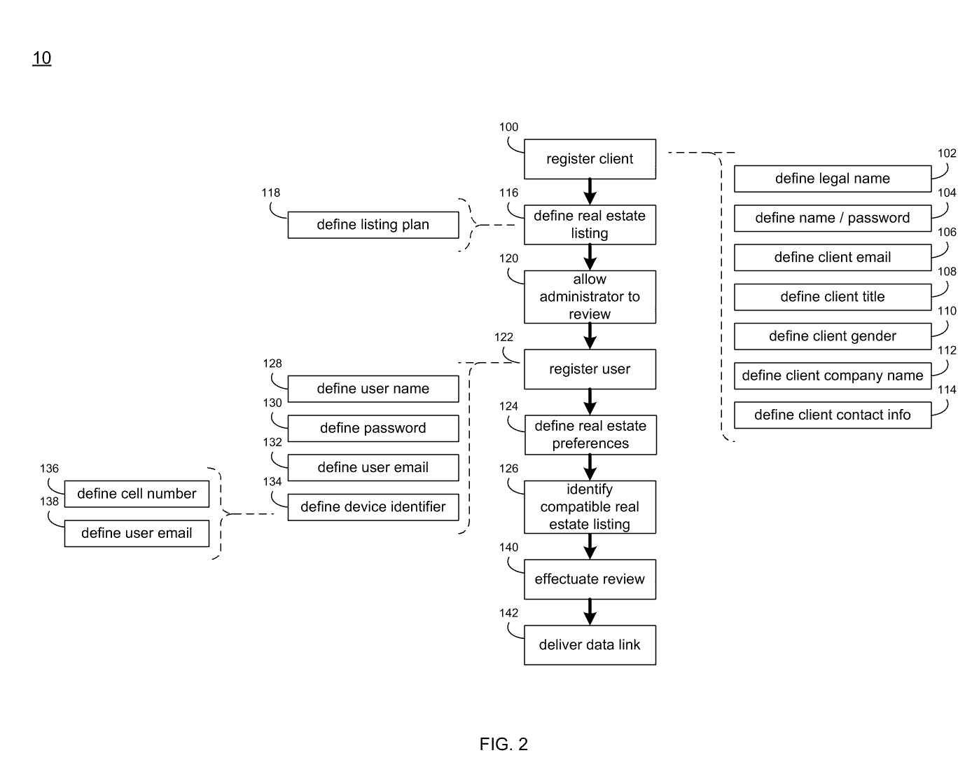

Referring also to FIGS. 2 & 3, assume for illustrative purposes that client 16 would like to sell a piece of real estate. Examples of client 16 may include but are not limited to a real estate broker, a real estate listings agent, a real estate owner, or other qualified entities/individuals. Assume for this particular example that client 16 is a real estate broker.

Accordingly, client 16 may access information dissemination process 10 using e.g. web client application 34 executed on personal computer 50. Upon accessing information dissemination process 10 (alone or in combination with web server application 30), information dissemination process 10 may render registration/log in screen 150 that allows an unregistered client to register 100 to use information dissemination process 10. Alternatively, registration/log in screen 150 may allow previously-registered clients to access information dissemination process 10.

Continuing with the above-stated example, assume for illustrative purposes that client 16 is an unregistered client and therefore may utilize registration/log in screen 150 to register 100 to use information dissemination process 10. Accordingly, client 16 may utilize onscreen pointer 152, which may be controllable by a pointing device, such as a mouse (not shown), to select “Register Now” link 154 included within registration/log in screen 150.

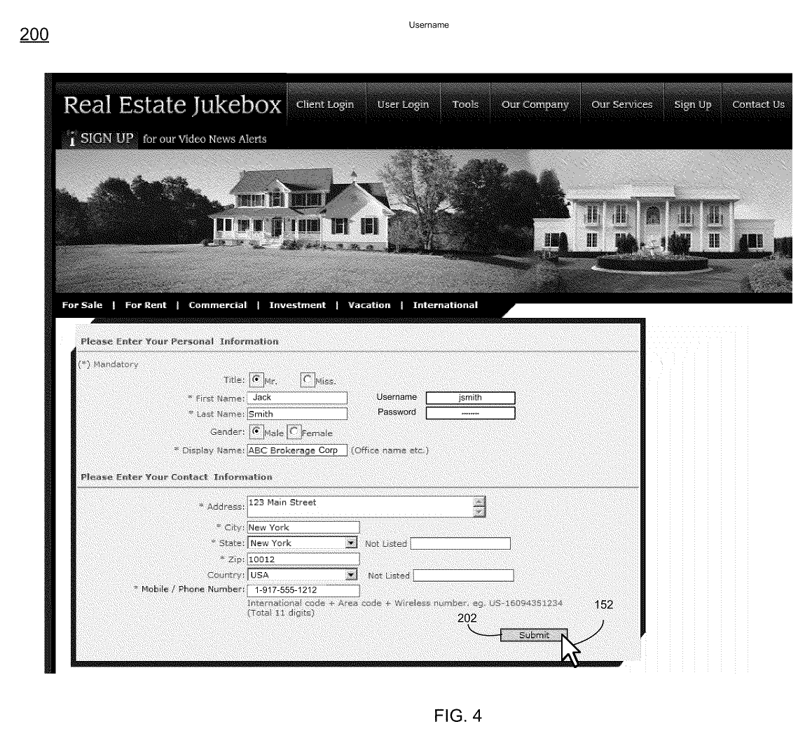

Upon selecting “Register Now” link 154 included within registration/log in screen 150 and referring also to FIG. 4, information dissemination process 10 may render client registration screen 200. Client registration screen 200 may include a plurality of editable fields that allow client 16 to e.g. define 102 their legal name; define 104 a user name and/or password; define 106 an e-mail address; define 108 a title; define 110 a gender; define 112 a company name; and define 114 contact information.

Assume for illustrative purposes that client 16 is a male broker named Jack Smith who works at ABC Brokerage Corp located at 123 Main St., New York, N.Y. 10012 and has a phone number of 917-555-1212. Once client 16 completes client registration screen 200, client 16 may select submit button 202 using onscreen pointer 152, resulting in client 16 being registered to use information dissemination process 10.

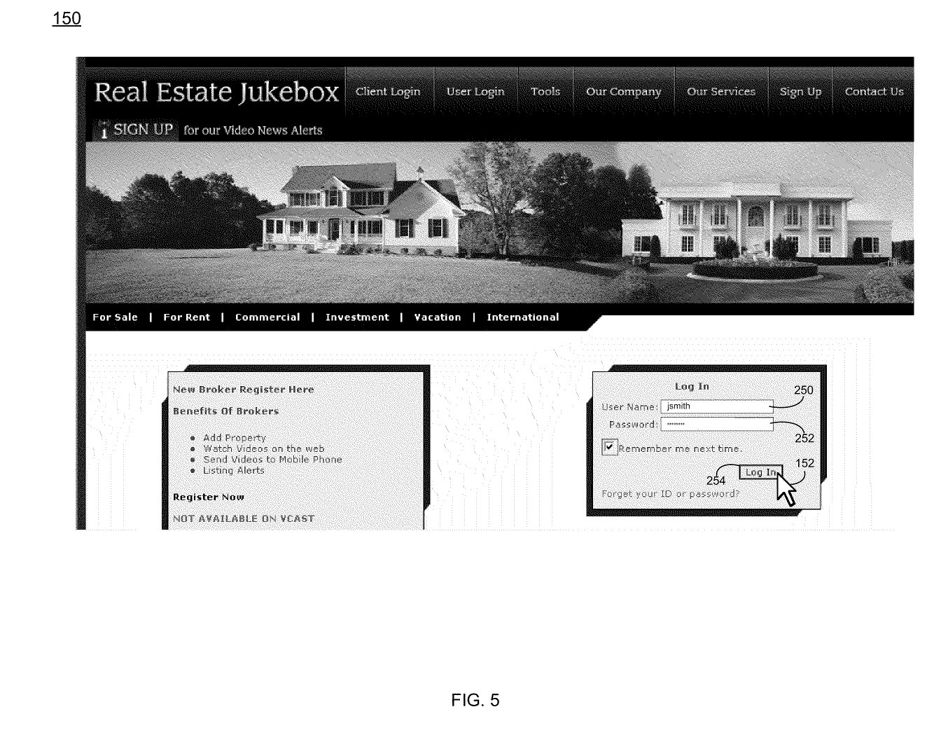

As discussed above and referring also to FIG. 5, if client 16 had previously-registered to use information dissemination process 10, client 16 may use registration/log in screen 150 to log into information dissemination process 10. Specifically, client 16 may enter their username into username field 250 and may enter their password into password field 252 and select “Log In” button 254 using onscreen pointer 152.

Once registered 100 with information dissemination process 10, client 16 may be allowed to define 116 one or more real estate listings for each of a plurality of available properties that client 16 would like to offer (e.g. to third parties) via information dissemination process 10. For example, if client 16 has ten properties to sell, client 16 may define 116 a real estate listing for each of the ten properties.

While in this particular example, information dissemination process 10 is being discussed as if it is being used by a single client (e.g. client 16), this is for illustrative purposes only and is not intended to be a limitation of the disclosure, as other configurations are possible. Specifically and in a typical embodiment of information dissemination process 10, a plurality of clients may be simultaneously utilizing information dissemination process 10, wherein each of the plurality of clients is generating listings for the various properties they wish to offer through information dissemination process 10. Accordingly, a plurality of available real estate listings (e.g. plurality of listings 20) may be defined 116 and offered to e.g. third parties via information dissemination process 10.

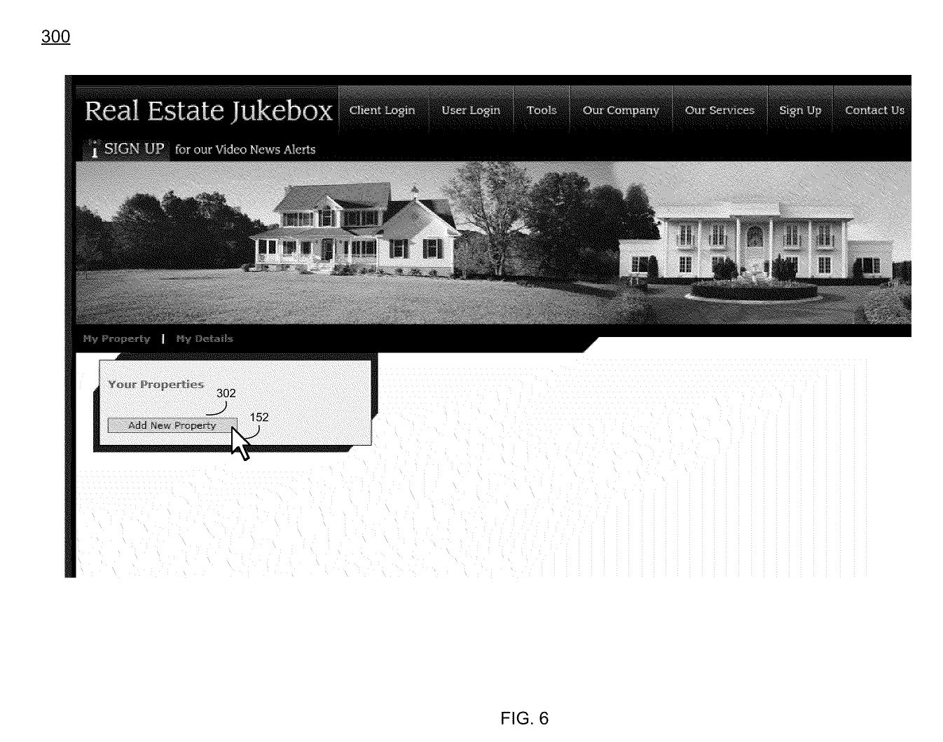

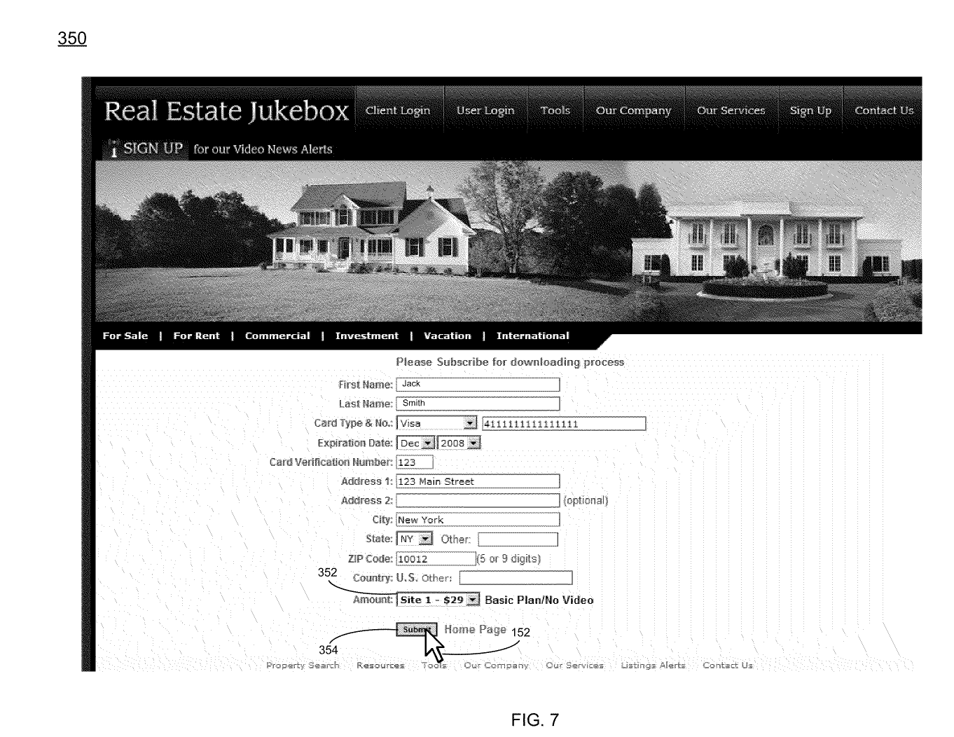

For example and referring also to FIG. 6, assume for illustrative purposes that client 16 has an available property that client 16 would like to offer to e.g. third parties via information dissemination process 10. Accordingly and through the use of property listing screen 300, client 16 may utilize onscreen pointer 152 to select “Add New Property” button 302. Once “Add New Property” button 302 is selected and referring also to FIG. 7, listing purchase screen 350 may be rendered by information dissemination process 10.

Listing purchase screen 350 may include a plurality of editable fields that may allow client 16 to define 118 a listing plan for the real estate listing being defined 116. Specifically, when defining 116 a real estate listing, client 16 may define one or more data items for each real estate listing defined. Examples of such data items may include but are not limited to: a textual description of an available property, a map locating the available property, a still image of the available property, and a video clip of the available property.

Accordingly, when defining 118 a listing plan for the real estate listing being defined 116, client 16 they choose between a plurality of plans (via e.g., drop down menu 352), each of which allows the user to define a different set of data items for the real estate listing being defined.

For example, a “Site 1” listing plan may only allow client 16 to include still images of the available property associated with the real estate listing being defined 116. However, a “Site 2” listing plan may allow client 16 to include still images and “shorter” videos of the available property associated with the real estate listing being defined 116. Further, a “Site 3” listing plan may allow client 16 to include still images and “longer” videos of the available property associated with the real estate listing being defined 116. Additional listing plans may e.g. offer more prominent placement within information dissemination process 10, may be listed as “specials”, or may be listed as “featured properties”. While the above described listing plans are meant to be illustrative, they are not meant to be exhaustive. Accordingly, other listing plans are considered to be within the scope of disclosure.

In addition to the above-described listing plans offering different data items to client 16, each of the above-described listing plans may be priced differently in accordance with the comprehensiveness of the data items included. For example, a listing plan that only allows client 16 to include still images of the available property (e.g. a “Site 1” listing plan) may be a modestly priced plan (e.g. $29). However, a listing plan that allows client 16 to include still images and “shorter” videos of the available property (e.g. a “Site 2” listing plan) may be a mid-price plan (e.g. $59). Further, a more comprehensive listing plan that allows client 16 to include still images and “longer” videos of the available property (e.g. a “Site 3” listing plan) may be a higher priced plan (e.g. $89).

When populating listing purchase screen 350, client 16 may be required to provide billing information, examples of which may include but is not limited to the first name of client 16, the last name of client 16, credit card type, credit card number, credit card expiration date, credit card verification number, billing address, billing city, billing state, and billing ZIP code. Once the requisite billing information is entered into listing purchase screen 350 and the appropriate listing plan is selected (via drop-down menu 352), client 16 may select “Submit” button 354 using onscreen pointer 152.

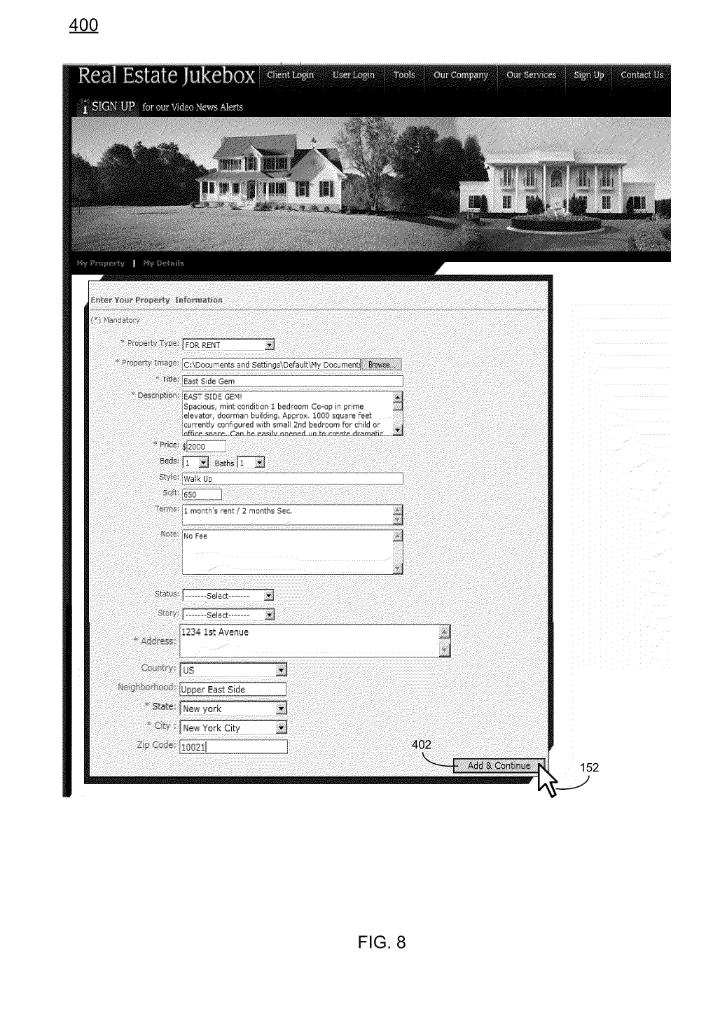

Referring also to FIG. 8, once “Submit” button 354 is selected by client 16, listing definition screen 400 may be rendered by information dissemination process 10. As discussed above, when defining 116 a real estate listing, client 16 may define one or more data items for each real estate listing defined, and an example of such a data item may include a textual description of an available property. Examples of such textual descriptions of the available property may include one or more of: an available property type (e.g. a rental property, a single-family home, a multifamily home, an investment property, or a condo); the street address of the available property (e.g. 1234 1^{st} Avenue); the neighborhood in which the available property is located (e.g. “Upper East Side”); the city in which the available property is located (e.g. New York City); the State in which the available property is located (e.g. New York); the ZIP code in which the available property is located (e.g. 10021); the country in which the available property is located (e.g. US); the price at which the available property is offered (e.g. $2000 per month in rent); the square footage of the available property (e.g. 650 ft.²); the number of bedrooms of the available property (e.g. one bedroom); the number of bathrooms of the available property (e.g. one bathroom); the title of the available property (e.g. “East Side Gem”); and the style descriptor of the available property (e.g. “Walk Up”). Once the requisite textual descriptions are entered into listing definition screen 400, client 16 may select “Add & Continue” button 402 using onscreen pointer 152.

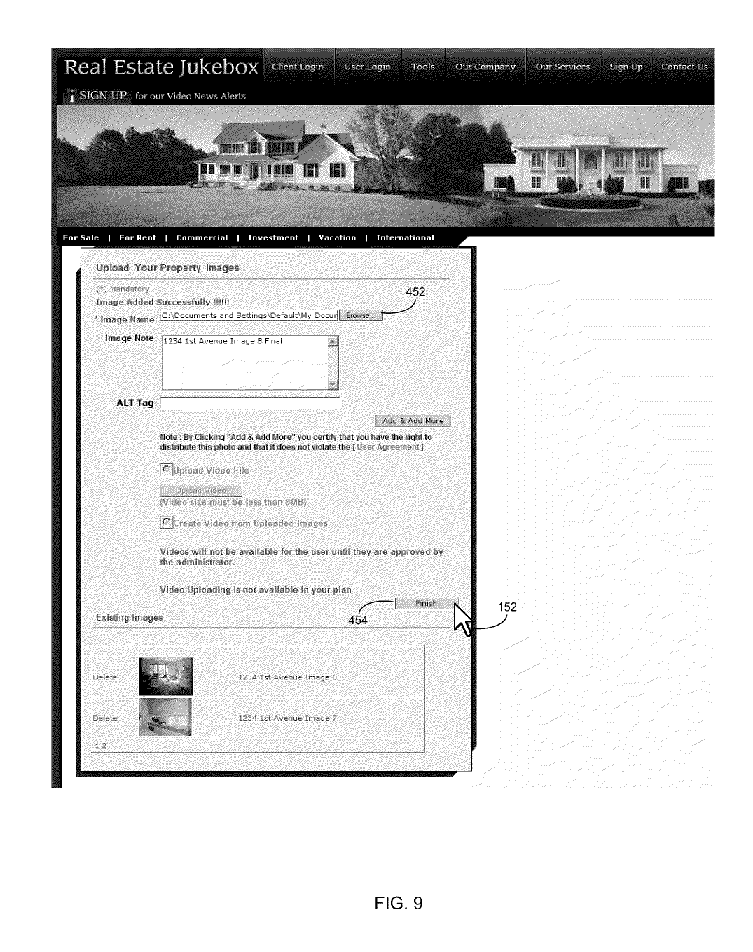

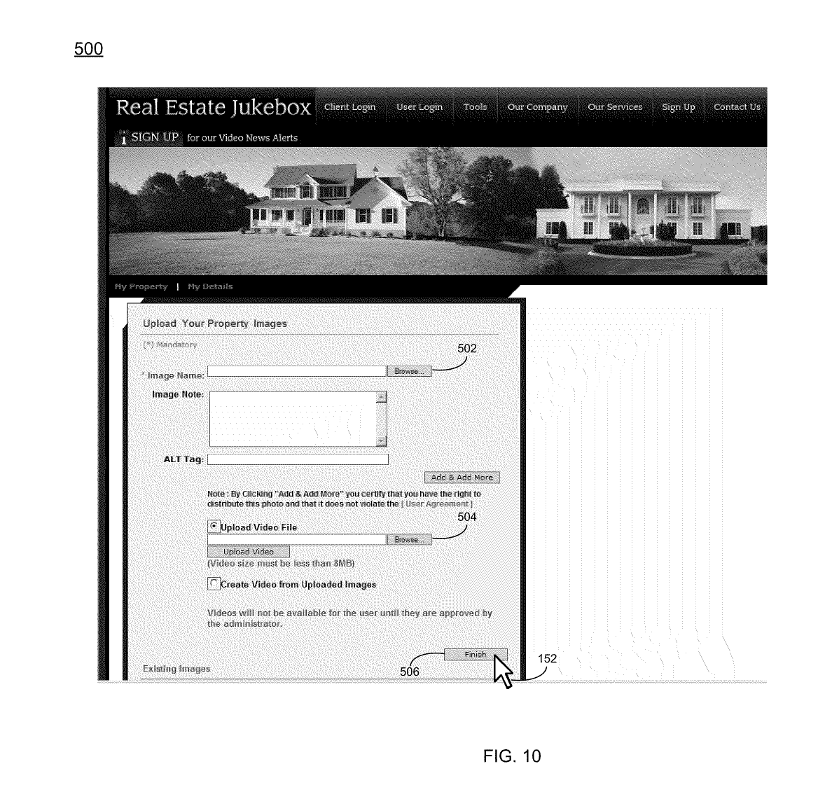

As discussed above, depending on the particular listing plan that client 16 chooses, client 16 may or may not be able to upload videos for distribution via information dissemination process. Accordingly, the particular screen rendered by information dissemination process 10 may vary depending upon the particular listing plan chosen by client 16. For illustrative purposes and referring also to FIG. 9, if (in this example) client 16 chooses e.g. a “Site 1” listing plan (i.e., no video), information dissemination process 10 may render image upload screen 450 that allows client 16 to upload still images via image location field 452. Once the appropriate images are uploaded, client 16 may select “Finish” button 454 using onscreen pointer 152. Alternatively and referring also to FIG. 10, if (in this example) client 16 chooses e.g. a “Site 2” or “Site 3” listing plans (i.e., videos), information dissemination process 10 may render image/video upload screen 500 that allows client 16 to upload still images and videos via image location field 502 and video location field 504 (respectively). Once the appropriate images/videos are uploaded, client 16 may select “Finish” button 506 using onscreen pointer 152.

Information dissemination process 10 may be configured to allow an administrator 70 to review/approve 120 the one or more data items. For example, information dissemination process 10 may be configured to allow/require that administrator 70 review and approve all still images and videos to confirm that they do not include any inappropriate content prior to allowing the images/videos to be available via information dissemination process 10. Further, information dissemination process 10 may be configured to only allow a real estate listing to be available via information dissemination process 10 once the chosen listing plan has been paid for (e.g. once the credit card charge has been approved).

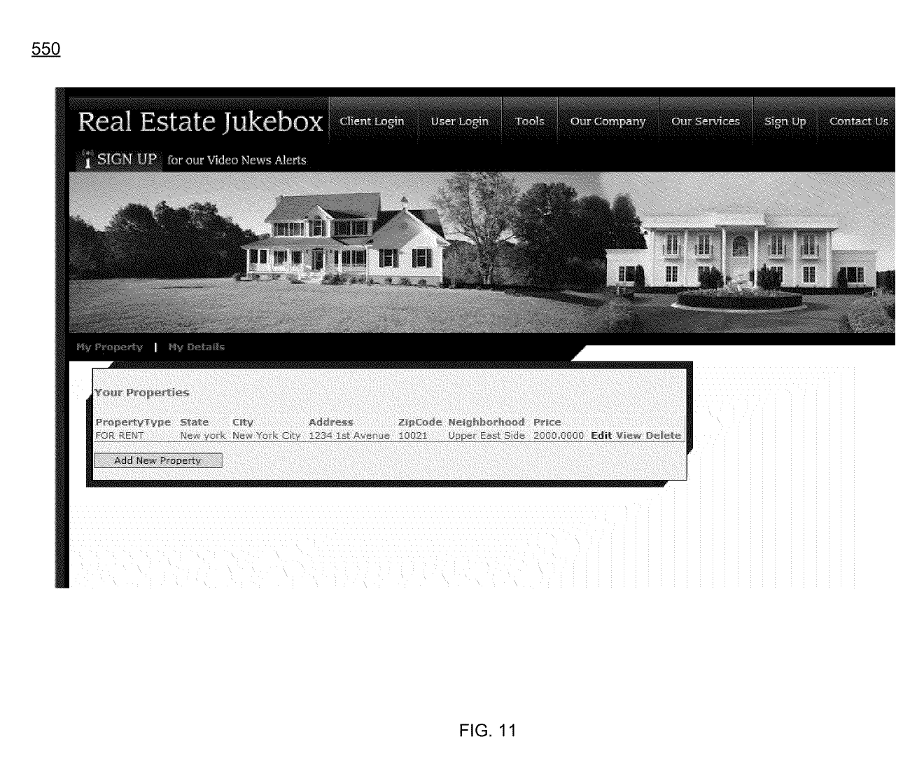

Referring also to FIG. 11, once “Finish” button 454 (FIG. 9) or “Finish” button 506 (FIG. 10) is selected by the client 16, listing confirmation screen 550 may be rendered by information dissemination process 10 to confirm the real estate listing(s) defined 116 by client 16.

In addition to registering 100 clients, information dissemination process 10 may be configured to register 122 users (e.g., user 22) of information dissemination process 10. As used in this disclosure, a user may be anyone that visits and uses information dissemination process 10. Accordingly, a person that is actively looking to purchase an available property, passively looking to purchase an available property, or just interested in sampling the offerings of information dissemination process 10 may be considered a user.

When a user (e.g. user 22) accesses information dissemination process 10, information dissemination process 10 may render preliminary search screen 600 that allows user 22 to define 124 one or more real estate preferences. Examples of such real estate preferences may include but are not limited to a preferred region of the country; a preferred state; a preferred neighborhood; a preferred street; a preferred ZIP code; a preferred price range; a preferred type of available property (e.g. a rental property, a single-family home, a multifamily home, an investment property, or a condo); a preferred price range; a preferred number of bedrooms; and a preferred number of bathrooms. Assume for illustrative purposes that user 22 selects “New York City” as the area in which they want to search. Upon selecting the appropriate search criteria, information dissemination process 10 may query plurality of listings 20 to identify 126 at least one compatible real estate listing based upon the one or more real estate preferences defined 124 by user 22.

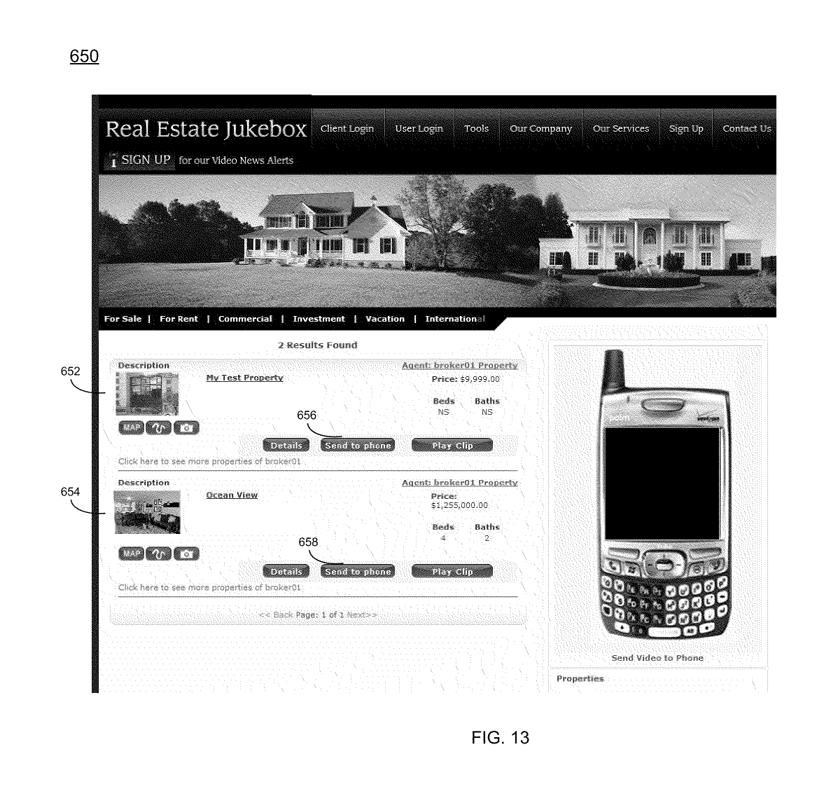

Referring also to FIG. 13, assume that information dissemination process 10 identified 126 two compatible real estate listings, namely real estate listing 652 and real estate listing 654 (which were chosen from plurality of available real estate listings 20). Information dissemination process 10 may be configured to allow an unregistered user to search plurality of available real estate listings 20 and generate a result set (e.g., real estate listing 652 and real estate listing 654) prior to becoming a registered user. Alternatively, information dissemination process 10 may be configured to require a user to register prior to searching plurality of available real estate listings 20 and prior to generating a result set.

Assume for illustrative purposes that in this particular embodiment, information dissemination process 10 is configured to allow an unregistered user to search plurality of available real estate listings 20 and generate a result set (e.g., real estate listing 652 and real estate listing 654) prior to becoming a registered user. However, prior to being able to review the individual real estate listings within the result set, user 22 must become a registered user.

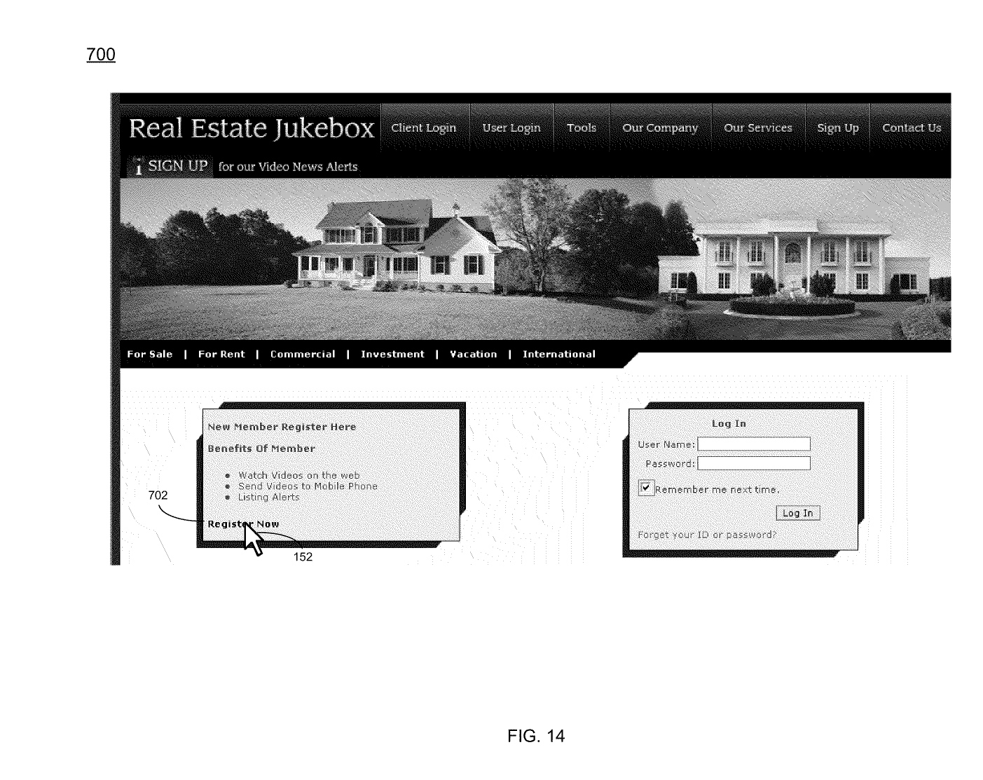

Accordingly and referring also to FIG. 14, when registering 122 a new user, information dissemination process 10 may render registration/log in screen 700. As with registration/log in screen 150, registration/log in screen 700 may allow registered users to log in and may allow unregistered users to register.

Continuing with the above-stated example, assume for illustrative purposes that user 22 is an unregistered user and therefore may utilize registration/log in screen 700 to register 122 to use information dissemination process 10. Accordingly, user 22 may utilize onscreen pointer 152, to select “Register Now” link 702 included within registration/log in screen 700.

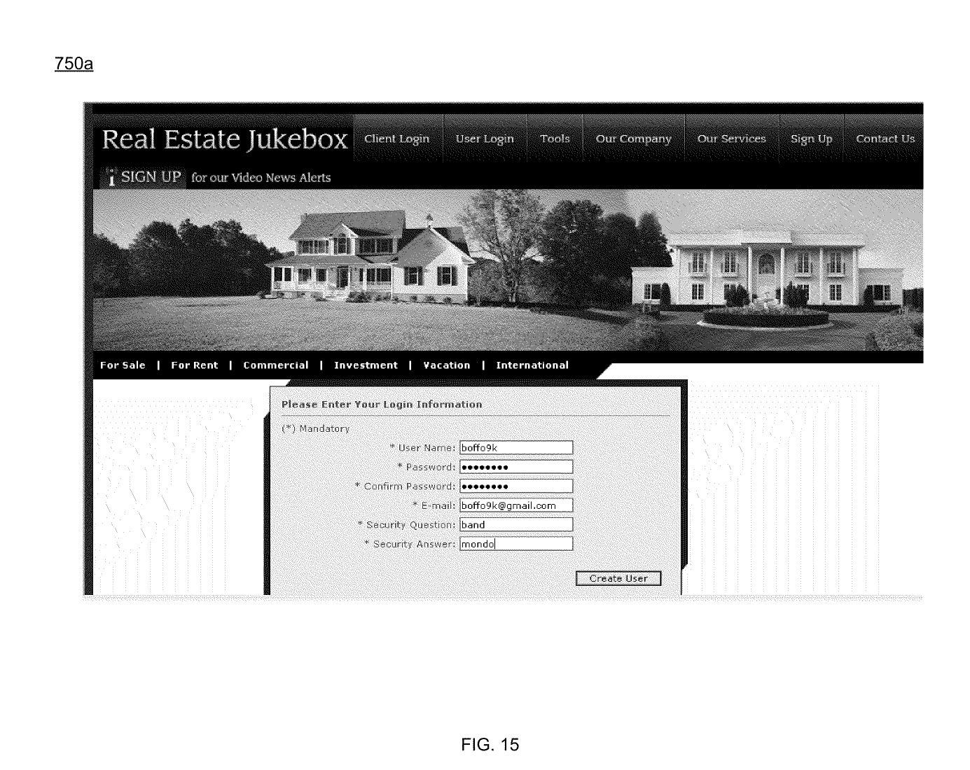

Upon selecting the “Register Now” link 702 within registration/log in screen 700 and referring also to FIGS. 15 & 16, information dissemination process 10 may render user registration screens 750a & 750b. User registration screens 750a & 750b may include a plurality of editable fields that allow user 22 to e.g. define 128 their user name (e.g., boffo9k); define 130 their password; and define 132 an e-mail address (e.g., boffo9k@gmail.com). User registration screens 750a & 750b may further allow user 22 to define their first name; define their last name; define their date of birth; define their gender; define their address; define their city of residence; define their state of residence; define their ZIP code; define their country of residence; and define 134 a unique identifier for the handheld electronic device (e.g., cellular telephone 26) of the user.

Defining 134 a unique identifier for the handheld electronic device of the user may include one or more of: defining 136 a cellular telephone number for e.g., cellular telephone 26 (for use with SMS protocol messaging); and defining 138 an email address for e.g., cellular telephone 26 (for use with MMS protocol messaging).

Once the requisite user information is entered into user registration screens 750a & 750b, information dissemination process 10 may effectuate 140 the review of at least a portion of the data items associated with the compatible real estate listing(s) on the handheld electronic device (e.g., cellular telephone 26) of the user (e.g., user 22). Effectuating 140 review may include delivering 142 a data link (not shown) to e.g., cellular telephone 26 via a messaging protocol (e.g., Short Message Service (SMS) protocol or a Multimedia Messaging Service (MMS) protocol). Once received by e.g., cellular telephone 26, the link (not shown) may effectuate review of the data items associated with the compatible real estate listing(s) on cellular telephone 26.

For example, information dissemination process 10 may generate a text message that is provided (using SMS protocol or MMS protocol) to cellular telephone 26. Within this text message, the above described link may be defined. When e.g. user 22 selects the above-described link using cellular telephone 26, one or more of the above described data items associated with the compatible real estate listing(s) may be rendered on e.g. cellular telephone 26. Specifically, the above-described data link may be processable via a Wireless Application Protocol (WAP) and, therefore, viewable via a WAP portal using a mobile browser executed on cellular telephone 26. As discussed above, examples of the above-described data items may include but are not limited to a textual description of an available property, a map locating the available property, a still image of the available property, and a video clip of the available property. Accordingly, through the use of information dissemination process 10, user 22 may review text-based descriptions of available properties, reviews still images of the available properties, and watch videos of the available properties that are streamed to cellular telephone 26. Further, if e.g. cellular telephone 26 is GPS enabled, the GPS system (not shown) included within cellular telephone 26 may interface with the above-describe map that locates the available property and may navigate user 22 to the location of the available property.

One or more of the above-described data items may be compressed using one or more known compression techniques.

While a system is described above as allowing user 22 to select (e.g. via buttons 656, 658, FIG. 13) which of the compatible real estate listings to provide (via the above-described data links) to cellular telephone 26, this is for illustrative purposes only and is not intended to be a limitation of this disclosure, as other configurations are possible. For example, information dissemination process 10 may be configured so that the above-described plurality of available real estate listings 20 is repeatedly queried (using the above-described real estate preferences) to identify 126 additional compatible real estate listings. In the event that such additional compatible real estate listings are identified 126, information dissemination process 10 may generate text messages that are provided (using SMS protocol or MMS protocol) to cellular telephone 26 that define the appropriate data link to the appropriate WAP portal.

A number of implementations have been described. Nevertheless, it will be understood that various modifications may be made. Accordingly, other implementations are within the scope of the following claims.

What is claimed is:

1. An information dissemination method comprising:
allowing one or more clients to define a real estate listing for each of a plurality of available properties, thus defining a plurality of available real estate listings, wherein each of the plurality of available real estate listings includes one or more data items;
allowing a user to define one or more real estate preferences;
identifying at least one compatible real estate listing for the user based upon the one or more real estate preferences, wherein the at least one compatible real estate listing is chosen from the plurality of available real estate listings; and
effectuating review, on a handheld electronic device of the user, of at least a portion of the one or more data items of the at least one compatible real estate listing.

2. The information dissemination method of claim 1 further comprising:
registering the client.

3. The information dissemination method of claim 2 wherein registering the client includes one or more of:
defining a client legal name;
defining a client username and/or password;
defining a client email address;
defining a client title;
defining a client gender;
defining a client company name; and
defining client contact information.

4. The information dissemination method of claim 1 wherein the client is a real estate broker.

5. The information dissemination method of claim 1 wherein defining a real estate listing includes:
defining a listing plan for the real estate listing.

6. The information dissemination method of claim 1 wherein the one or more data items include one or more of:
a textual description of an available property,
a map locating the available property,
a still image of the available property, and
a video clip of the available property.

7. The information dissemination method of claim 6 wherein the textual description of the available property includes one or more of:
an available property type,
an available property city,
an available property state,
an available property price,
an available property number of bedrooms,
an available property number of bathrooms,
an available property title, and
an available property style descriptor.

8. The information dissemination method of claim 1 wherein the one or more real estate preferences include one or more of:
a preferred property type,
a preferred city,
a preferred state, and
a preferred price range.

9. The information dissemination method of claim 1 further comprising:
registering the user, wherein registering the user includes one or more of:
defining a user name;
defining a user password;
defining a user email address, and
defining a unique identifier for the handheld electronic device of the user.

10. The information dissemination method of claim 9 wherein defining a unique identifier for the handheld electronic device of the user includes one or more of:
defining a cellular telephone number for the handheld electronic device of the user; and
defining an email address for the handheld electronic device of the user.

11. The information dissemination method of claim 1 wherein effectuating review includes:
delivering a data link to the handheld electronic device of the user via a messaging protocol, wherein the link effectuates review, on the handheld electronic device of the user, of the at least a portion of the one or more data items of the at least one compatible real estate listing.

12. The information dissemination method of claim 11 wherein the messaging protocol includes one or more of:
a Short Message Service (SMS) protocol; and
a Multimedia Messaging Service (MMS) protocol.

13. The information dissemination method of claim 11 wherein the data link is processable via a Wireless Application Protocol (WAP).

14. The information dissemination method of claim 1 further comprising:
allowing an administrator to review/approve the one or more data items.

15. A computer program product residing on a computer readable medium having a plurality of instructions stored thereon which, when executed by a processor, cause the processor to perform operations comprising:
allowing one or more clients to define a real estate listing for each of a plurality of available properties, thus defining a plurality of available real estate listings, wherein each of the plurality of available real estate listings includes one or more data items;
allowing a user to define one or more real estate preferences;
identifying at least one compatible real estate listing for the user based upon the one or more real estate preferences, wherein the at least one compatible real estate listing is chosen from the plurality of available real estate listings; and
effectuating review, on a handheld electronic device of the user, of at least a portion of the one or more data items of the at least one compatible real estate listing.

16. The computer program product of claim 15 further comprising instructions for:
registering the client.

17. The computer program product of claim 16 wherein the instructions for registering the client include instructions for one or more of:
defining a client legal name;
defining a client username and/or password;
defining a client email address;
defining a client title;
defining a client gender;
defining a client company name; and
defining client contact information.

18. The computer program product of claim 15 wherein the client is a real estate broker.

19. The computer program product of claim 15 wherein the instructions for defining a real estate listing include instructions for:
defining a listing plan for the real estate listing.

20. The computer program product of claim 15 wherein the one or more data items include one or more of:
a textual description of an available property,
a map locating the available property,
a still image of the available property, and
a video clip of the available property.

21. The computer program product of claim 20 wherein the textual description of the available property includes one or more of:
an available property type,
an available property city,
an available property state,
an available property price,
an available property number of bedrooms,
an available property number of bathrooms,
an available property title, and
an available property style descriptor.

22. The computer program product of claim 15 wherein the one or more real estate preferences include one or more of:
a preferred property type,
a preferred city,
a preferred state, and
a preferred price range.

23. The computer program product of claim 15 further comprising instructions for:
registering the user, wherein registering the user includes one or more of:
defining a user name;
defining a user password;
defining a user email address, and
defining a unique identifier for the handheld electronic device of the user.

24. The computer program product of claim 23 wherein the instructions for defining a unique identifier for the handheld electronic device of the user include instructions for one or more of:
defining a cellular telephone number for the handheld electronic device of the user; and
defining an email address for the handheld electronic device of the user.

25. The computer program product of claim 15 wherein the instructions for effectuating review include instructions for:
delivering a data link to the handheld electronic device of the user via a messaging protocol, wherein the link effectuates review, on the handheld electronic device of the user, of the at least a portion of the one or more data items of the at least one compatible real estate listing.

26. The computer program product of claim 25 wherein the messaging protocol includes one or more of:
a Short Message Service (SMS) protocol; and
a Multimedia Messaging Service (MMS) protocol.

27. The computer program product of claim 25 wherein the data link is processable via a Wireless Application Protocol (WAP).

28. The computer program product of claim 15 further comprising instructions for:
allowing an administrator to review/approve the one or more data items.
